(19) United States
(12) Patent Application Publication
(10) Pub. No.: US 2018/0143950 A1
(43) Pub. Date: May 24, 2018

(54) INTERACTIVE COMMUNICATION VIA ONLINE VIDEO SYSTEMS

(71) Applicant: InGage Technologies, Inc., North Adams, MA (US)

(72) Inventors: Amir al-Arnaouti, Williamstown, MA (US); Juan Rolando Mena, III, North Adams, MA (US)

(21) Appl. No.: 15/816,917

(22) Filed: Nov. 17, 2017

Related U.S. Application Data
(60) Provisional application No. 62/423,838, filed on Nov. 18, 2016.

(51) Int. Cl. G06F 17/22; G06Q 50/00

(52) U.S. Cl. CPC G06F 17/2235; H04L 67/02; G06F 17/227; G06Q 50/01

(57) ABSTRACT

Embodiments include systems and methods that enable enrichment and sharing of online content between users. These systems and methods provide mechanisms that allow users to author and overlay metadata as transparent containers on already existing data containers within models of the online content, as well as to create relational connections between people and objects across the web by communicating the overlaid online content. The metadata and relationships may be collected from user-authored input by overlaying virtual transparent screens over the online content. The virtual transparent screens enable the users to share the content by visually marking, or otherwise indicating, locations of interest on the content through the virtual transparent screens. The users may then author input related to the marked locations to be placed in the transparent containers associated with the marked location. The enriched content is then processed and rendered to other users through the transparent containers.

### RELATED APPLICATION(S)

This application claims the benefit of U.S. Provisional Application No. 62/423,838, filed on Nov. 18, 2016. The entire teachings of the above application(s) are incorporated herein by reference.

### BACKGROUND

The advent of social networking sites and the proliferation of mobile devices have increasingly impacted the way content consumers discover, share, and engage with online content. While these sites and devices facilitate the sharing of content, they continue to impose serious limitations on the contextual sharing of the content, as well as, the granularity with which users can share the content. Currently, the sharing of content is facilitated by these sites and devices by allowing users to embed hyperlinks pointing to the content onto their social network pages, or attach such hyperlinks to messages sent to other users through messaging applications. Thumbnails of the shared content are then rendered on the sharer's social networking page, if the content is shared through a social network, or from the hyperlinks within the received message, if forwarded through a messaging application, making the content accessible to other users with whom the content is shared. The other users must then select the thumbnails or hyperlinks to access the content separately from the shared messages regarding the content.

### SUMMARY OF THE DISCLOSURE

In this way, through current sites and devices, online content is shared in its entirety, and the sharer's ability to select and share specific segments of the content, or point to specific locations within the shared content, is not possible. As such, a sharer providing comments regarding the specific segments or locations of the shared content is also not possible. That is, users with whom the content is shared in this manner are limited to engaging with the content devoid of intra-content comments. For example, re-sharing the content information entails posting comments in areas dedicated for user comments, usually located below the content, or indicating sentiments with respect to the content through star rating, emoticon systems, or the like. The shared content is usually separately viewed by selecting an application that opens the content on an interface of the social networking website or by redirecting a user to the original hosting page of the content.

The following example illustrates these limitations. As a user is enjoying viewing online content of their choosing (e.g., video, images, audio, or such) via a communications network, the user is usually limited in his/her interactions with other users (friends, family, peers, and the like) in relation to said content. For example, for a first user to perform an act as simple as pointing out (sharing) content of a moment in a video to a second user, the first user must collect the website link, or Universal Resource Locator (URL), for the video and the time information related to the video moment. The first user must, then, convey both the URL and the time information to the second user through a channel separate from the video channel, such as a third-party messaging application or social networking channel. The URL may be used by the second user to locate and display the content to share. The time information related to the video moment conveyed by the first user must to be sufficient for the second user to locate the moment in the video (as accessed by the video link). However, based solely on the time information, the second user still only has a general idea as to the specific content that the user intends to point out at the moment in the video. This issue is especially true in asynchronous situations where the first user and the second user are viewing the content at different times.

Further, the second user usually has to explore the shared video content (in view of the time information) apart from the first user, and separately form a conclusion regarding the content intended to be shared by the first user. If the second user wishes to reply to the first user regarding the shared content, the second user must also access a separate channel from the video channel, such as the third-party messaging application or other network communication channel/platform, to communicate the reply to the first user.

Embodiments of the present disclosure enable enrichment and sharing of online content between users. These embodiments provide mechanisms that allow users to author and overlay metadata as transparent containers on already existing data containers within models of the online content, as well as to create relational connections between people and objects across the web by communicating the overlaid online content. The metadata and relationships may be collected from user-authored input by overlaying virtual transparent screens over the online content. The virtual transparent screens enable the users to share the content by visually marking, or otherwise indicating, locations of interest on the content through the virtual transparent screens. The users may then author input related to the marked locations to be placed in the transparent containers associated with the marked location. The enriched content is then processed by an application back end service and rendered to other users through the transparent containers.

Some embodiments include an application (plugin) that enables the user to overlay the authored metadata on the already existing data containers (e.g., HTML objects) within the webpage structure of the content. To do so, the application, which may be part of an online content communication engine, overlays the transparent containers onto existing data containers of the webpage structure. The transparent containers are used as input receptors through which a user may directly select or mark the content through the display device. The overlaid transparent containers provide a virtual transparent screen over online content being viewed on the webpage by a user. The application further enables a user to select the transparent screen to mark, or otherwise indicate, a portion of the online content and share information regarding the marked portion of the online content with other users. The application also receives shared information from other users regarding a portion of the online content. The application visually marks, or otherwise indicates, on the transparent screen over the received marked portion of the online content and presents the shared information regarding this portion of the online content to the user. In some embodiments, the marking on the overlay is similar to pointing on a television screen.

Example embodiments are directed to computer systems and methods that enable user interactive communication via online content. The systems and methods analyze online content displayed at a computing device of a first user via executing a third-party web client. The displayed online content structured in a third-party data model, such as a document object model (DOM). The displayed online content may be at least one of: an image, a video, an audio recording, or any other content without limitation. The systems and methods generate a transparent context layer on the online content by attaching elements to existing objects of the document object model to generate the transparent context layer. In some embodiments, the existing objects comprise HTML objects, including a video HTML5 element tag. In embodiments, the generating of the transparent context layer may include: identifying objects in the document object model based on type of the objects and extracting and dissecting the identified objects based on element type and known structure of the document object model to select a subset of the identified objects. The generating of the transparent context layer may further include: for each of the subset of selected objects, attaching a new element to the respective selected object within the document object model, the attached new elements comprising the transparent context layer. In some embodiments, CSS styling places each of the attached new elements at a higher z-index than the respective selected object within a stacking context, or at a higher stacking order than a stacking context to which the respective selected object is a descendant, such as an ancestor node's stacking context, to enable each of the attached new elements to visually overlap above the respective selected object.

The systems and methods may then select (or enable a user to select) a portion of the displayed online content, the selected portion mapping to an existing object of the document object model. In some embodiments, the selected portion is a specific moment in the online content. The systems and methods provide (or enable a user to provide) information on the selected portion to communicate to a second user. The computing device may place the provided information in an element attached to the mapped existing object. In some embodiments, at least one of: a reference time and a position of a mapped object is also placed one or more of: in, around, and over a respective attached element. The systems and methods transmit the collected meta-data (reference time, position, page URL, object information, etc.) to a server, where the information is organized. The systems and methods then retrieve the information from the server using a second computing device of the second user. The systems and methods presenting, on the second computing device, the metadata generated and attached to the online content, native to the webpage's document object model, by the first user in the form of an HTML object attached directly to the transparent context layer attached to said content.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic diagram of an example computer network environment in which embodiments of the present invention are deployed.

FIG. 1B is a block diagram of certain components of the computer nodes in the network of FIG. 1A.

FIG. 2 is a use case diagram depicting an example use case in embodiments of the present invention.

FIG. 3A is a block diagram of an example method for injecting a Transparent Context Layer into a Document Object Model in embodiments of the present invention.

FIG. 3B is a block diagram of another example method for injecting a Transparent Context Layer into a Document Object Model in embodiments of the present invention.

FIG. 4A is a block diagram of example user interaction in embodiments of the present invention.

FIG. 4B is an example of an in-video conversation in an embodiment of the present invention.

FIG. 5 is a component diagram depicting components of the interactive communication platform in embodiment of the present invention.

FIG. 6 is a use case diagram depicting the use cases for creating and consuming in-video user-authored content through some embodiments of the present invention.

FIG. 7 is a use case diagram depicting an embodiment of the application back end component's use cases for creating in-video user-authored content in embodiments of the present invention.

FIG. 8 is a use case diagram depicting a method for pushing content from one user to another through some of the embodiments of the present invention.

FIG. 9 is a flow diagram of an example method for displaying video content in the interactive communication platform of FIG. 5.

FIG. 10 is a flow diagram of an example method for user interaction in the interactive communication platform of FIG. 6.

### DETAILED DESCRIPTION OF THE DISCLOSURE

A description of example embodiments of the invention follows.

### Digital Processing Environment

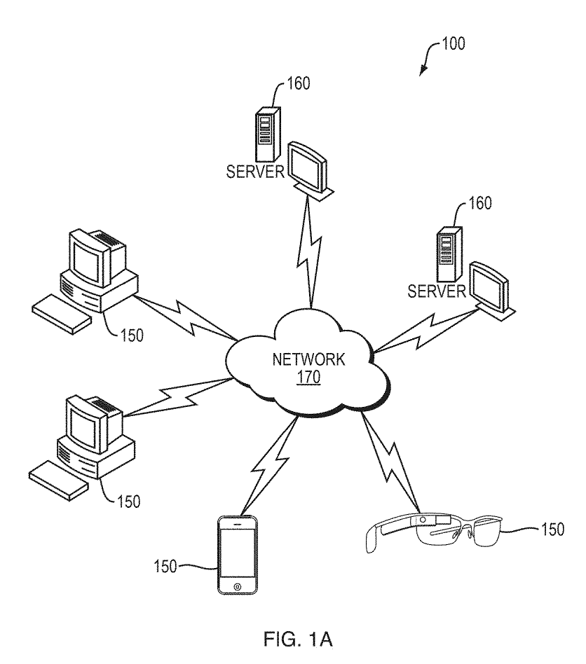

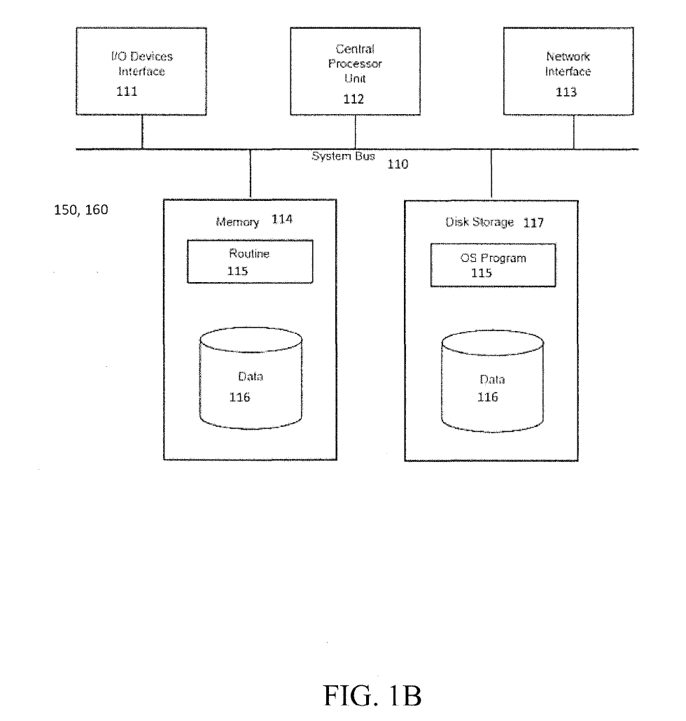

Example implementations of a system 100 that enables interactive communication via online content may be implemented in a software, firmware, or hardware environment. FIG. 1A illustrates one such environment. Client computer(s)/devices 150 (e.g. computer, mobile phone, and video camera) and a cloud 170 (or server computer or cluster thereof) provide processing, storage, and input/output devices executing application programs and the like.

Client computer(s)/devices 150 are linked through communications network 170 to other computing devices, including other client devices/processes 150 and server computer(s) 160. The cloud 170 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

Client computer(s)/devices 150 may be configured to perform as a web-based client and online content communication engine. Server computers 160 may be web-based servers (e.g., application servers, data servers, and such) that communication with the client computer(s)/devices (web-based clients) 150 to transmit/receive, store, and process online content in web-based format, such as webpages. The server computers 160 may not be separate server computers but part of cloud network 170. The client computer(s)/devices 150 may be configured with an application, such as (i) a web browser to load and display online content as a webpage and (2) an interactive communication application (plugin to the web browser) that enables sharing the online content along with messages regarding portions of the online content. The application interactive communication application configured on the client computer(s)/devices 150 may provide a virtual transparent screen for a user to interactively communication (message) regarding the online content with other users.

FIG. 1B is a block diagram of any internal structure of a computer/computing node (e.g., client processor/device 150 or server computers 160) in the processing environment of FIG. 1A, which may be used to facilitate processing audio, image, video or data signal information. Each computer 150, 160 in FIG. 1B contains a system bus 110, where a bus is a set of actual or virtual hardware lines used for data transfer among the components of a computer or processing system. The system bus 110 is essentially a shared conduit that connects different elements of a computer system (e.g., processor, disk storage, memory, input/output ports, etc.) that enables the transfer of data between elements.

Attached to the system bus 110 is an I/O device interface 111 for connecting various input and output devices (e.g., keyboard, mouse, touch screen interface, displays, printers, speakers, audio inputs and outputs, video inputs and outputs, microphone jacks, etc.) to the computer 150, 160. A network interface 113 allows the computer to connect to various other devices attached to a network (for example the network illustrated at 170 of FIG. 1A). Memory 114 provides volatile storage for computer software instructions 115 and data 116 used to implement software implementations of the present invention (e.g. providing a virtual transparent screen for interactively communicating via online content).

Software components 115, 116 of the interactive communication system 100 described herein may be configured using any programming language, including any high-level, object-oriented programming language or web-based language (e.g., HTML, CSS, etc.). The system 100 may include instances of processes that provide a virtual transparent screen by attaching transparent containers/objects to the existing objects of a webpage of online content. The system 100 may further include instances of processes that enable a user to select a portion of the online content and input associate messages regarding the selected portion by way of the transparent containers. The system 100 may also include instances of processes that present messages received from other users in regard to a selected portion of the online content (via the transparent containers). In some embodiments, the computing device 150 providing the virtual transparent screen may be implemented via a software embodiment and may operate, at least partially, within a browser session.

Disk storage 117 provides non-volatile storage for computer software instructions 115 (equivalently “OS program”) and data 116 used to implement embodiments of the system 100. The system may include disk storage 117 accessible to the server computer 160 or client computer(s) 150. The server computer 160 (e.g., application servers) or client computer (e.g., mobile device/web-based clients) may store information, such as webpages or other forms of online content on the disk storage 117. Central processor unit 112 is also attached to the system bus 110 and provides for the execution of computer instructions. Software implementations 115, 116 may be implemented as a computer readable medium capable of being stored on a storage device 117, which provides at least a portion of the software instructions for the controlled environment system. Executing instances of respective software components of the controlled environment system, may be implemented as computer program products 115, and can be installed by any suitable software installation procedure, as is well known in the art.

In another embodiment, at least a portion of the system software instructions 115 may be downloaded over a cable, communication and/or wireless connection via, for example, a browser SSL session or through an app (whether executed from a mobile or other computing device). In other embodiments, the system 100 software components 115, may be implemented as a computer program propagated signal product embodied on a propagated signal on a propagation medium (e.g. a radio wave, an infrared wave, a laser wave, a sound wave, or an electrical wave propagated over a global network such as the Internet, or other networks. Such carrier medium or signal provides at least a portion of the software instructions for the present controlled environment system 100 of FIG. 1A.

### Online Content

Online content is currently shared by providing to another user a Universal Resource Locator (URL) for a webpage associated with the content. This URL provides the location of the content being shared, as well as, additional information needed to retrieve the content. A URL is usually composed of a scheme (HTTP, HTTPS, etc.), hostname (in most cases also known as a domain name), and the path to the required resource (for example ‘/’, ‘index.html’, and such). The resource may be the page or file containing the shared content. For example, a file ‘/index.html’ typically contains the HTML code for the index page (often referred to as the home page). In some embodiments, the URL also contains a query string or fragment arguments to further enhance the URL functionality. For example, in some browsers, a fragment attribute of the fragment arguments, if provided with an HTML object identifier (ID), scrolls the loaded page to where said object is located.

The query string contained in the URL traditionally allows for the transfer of data to the server in the form of key and value pairs (parameters). This information may be used by a service to determine if a resource is loaded, which resource to load, how a resource is loaded, or actions said resource should take. A video, for example, may be instructed to begin playback at a specific point in time based on a provided parameter. Parameters and their functionality are dependent on the service providing the online content. When a user shares content with another user via an URL, the content is often limited and disconnected from the intent of the sharing user. This is because a URL in its raw format may be virtually meaningless to a recipient. In some cases the recipient might recognize the hostname on the URL, however, because query parameters and file paths depend on the service the hostname represents, there is not much context given to the recipient about the content that the recipient is receiving. To gain more insight, a user must follow the URL to the site where the content is located. The limited information provided by the URL may turn a user away from the shared content. As such, different social platforms have adopted the ability to render more information about the resource to which a URL points as a preview of sorts. This attempts to introduce the recipient to the content being shared.

This rendering functionality introduces its own limitations since, although the rendering adds more information to the sharing capabilities of a social platform, the scope of the message and its context within the shared content becomes diluted. The recipient may retain context of the content that is being shared by remaining on the social platform; however, this limits the granularity of the content being shared to the entire resource that contains it. The user knows that content is being shared with them, and may even know the general description of said content, but not any specifics of the content. This is because the rendered preview of the resource being shown to users tends to only include very general details about the content being shared. These details may be insufficient to identify the real content a user wanted to share. For example, a receiving user may be shown the general title and front image of a page being shared, whereas the sending user may have wanted to show the receiving user a specific video within the content that is not immediately apparent from the content preview being rendered on the messaging device. By visiting the content on the other hand, the user is taken from the current social platform and provided the content at its source. This allows the user to more accurately identify the shared content by giving the user a fuller access to the content, but the user is limited in their context since the message and additional content attached to the URL link still only exists within the messaging application. Additional ways to overcome this disconnect is to render the content directly from the social platform itself, as is the case with most video sharing on social media. However, even when such rendering of the page bridges the gap between context and granularity, there are still limitations since the URL addresses usually only carry so much data and functionality.

### Example Communication

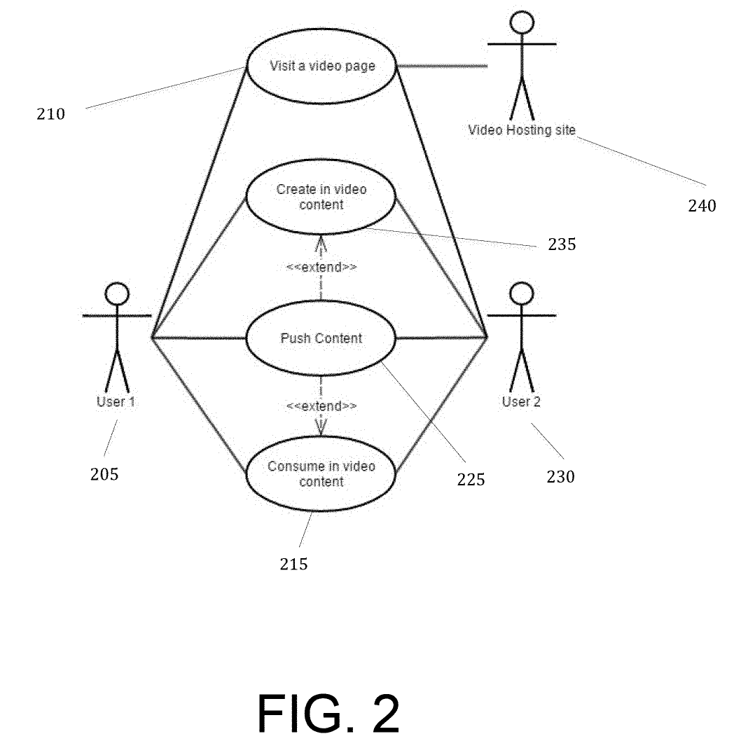

Embodiments of the present disclosure address such issues related to user interaction regarding online content. FIG. 2 is a use case diagram depicting an example use case in embodiments of the present invention. In the example use case in FIG. 2, a user (e.g., User 1 205) views already existing online content by visiting 210 a given webpage from a hosting site 240. In this example use case, a user (User 1 205) enriches the existing content by authoring/creating 235 new content on the given page, pushing 225 both the original and the newly authored content to others (e.g., users, such as User 2 230, platforms, sites, the world at large), and consuming content 215 authored by others (e.g., users, such as User 2 230, bots, automated processes) on the given page. Embodiments provide for the enriching and sharing web content by providing mechanisms (applications) that allow the users 205, 230 to author and overlay metadata with the use of transparent containers on already existing data containers within web applications, as well as create relational connections between conceptual objects, ideas, products, messages, people, etc. across the web.

The user interaction in FIG. 2 is performed via client devices, such as mobile devices, smartphones, tablets, desktops, or any other computing system that supports web-based client applications. These client devices may be configured as an online content communication engine that executes the web-based client application in conjunction with a web browser. In some embodiments, the web-based client application may be any of a messaging app, mobile app, smart television, video player, image galleries, or any of web-based application without limitation. In the embodiment of FIG. 2, the client devices are configured to execute a web-based browser application, which renders a page (webpage) containing content in a web-based format, such as HTML. In other embodiments, the client devices may be configured to execute other applications, including applications that do not require a browser, which render content in other formats without limitation. The web-based browser application is further configured to load an application that enables the user of the client devices to interactively communicate regarding the page content. The metadata and relationships are collected from user-authored input by overlaying a transparent context layer over the content being shared to allow users to visually mark, and provide the authored input in reference to, locations of interest on the content through these overlaid virtual transparent context layers. The enriched content is then processed and rendered through the same transparent containers.

### Transparent Content Layer

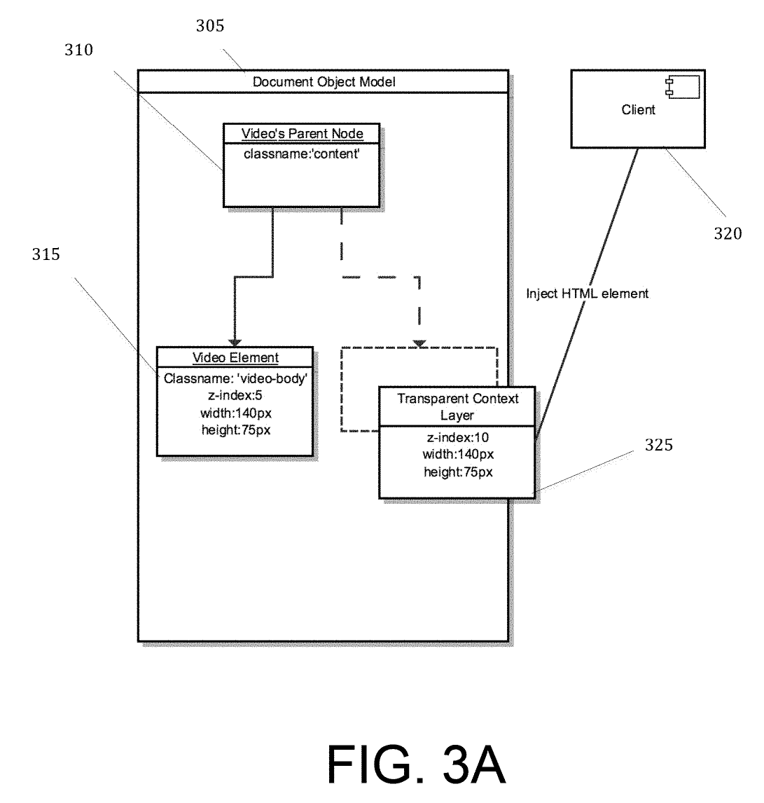

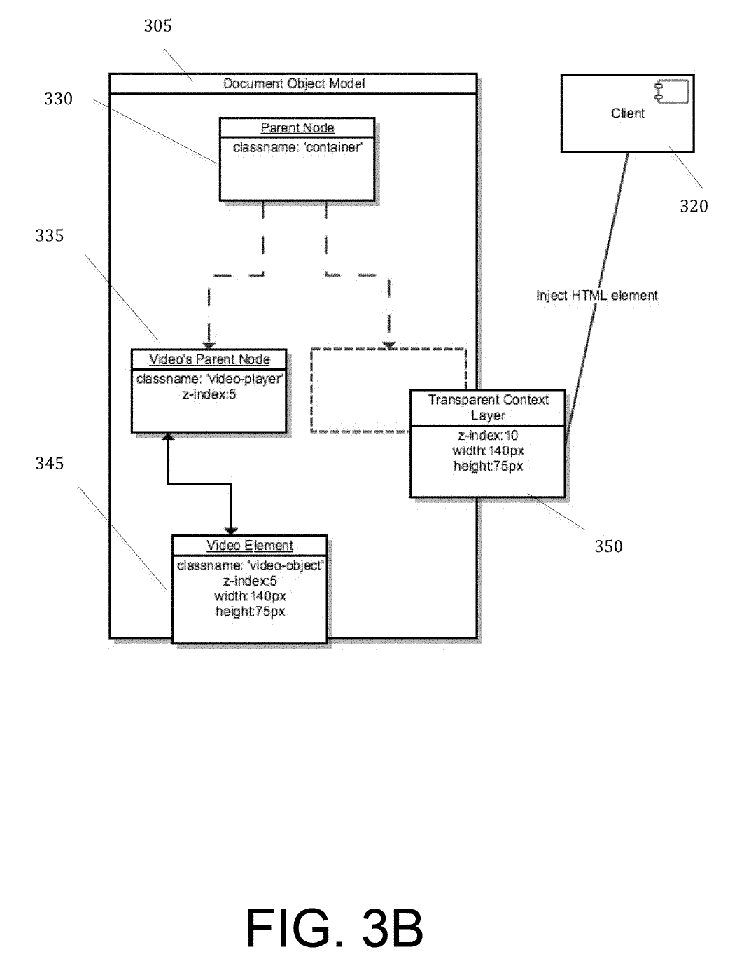

One key component in the present invention is the Transparent Context Layer (TCL). An embodiment of the TCL may be used to act as an input receptor and as a display for user-authored content. Other embodiments may be used for other content-based functions without limitation. The implementation of the TCL depends on the software or hardware environment the presented embodiment requires. FIGS. 3A and 3B are both examples of the TCL implemented as an HTML element being injected into a website's Document Object Model (DOM) 305. In FIG. 3A, the DOM includes an existing video parent node 310 with an existing video element 315. In FIG. 3B, the DOM includes an existing parent node 330 with an existing video parent node 335 with an existing video element 345. A transparent context layer element (TCL) 325 is injected into the existing video parent node 310 in FIG. 3A by a client 320 to provide a TCL. A transparent context layer element 350 is similarly injected into the existing parent node 330 in FIG. 3B by the client 320 to provide a TCL.

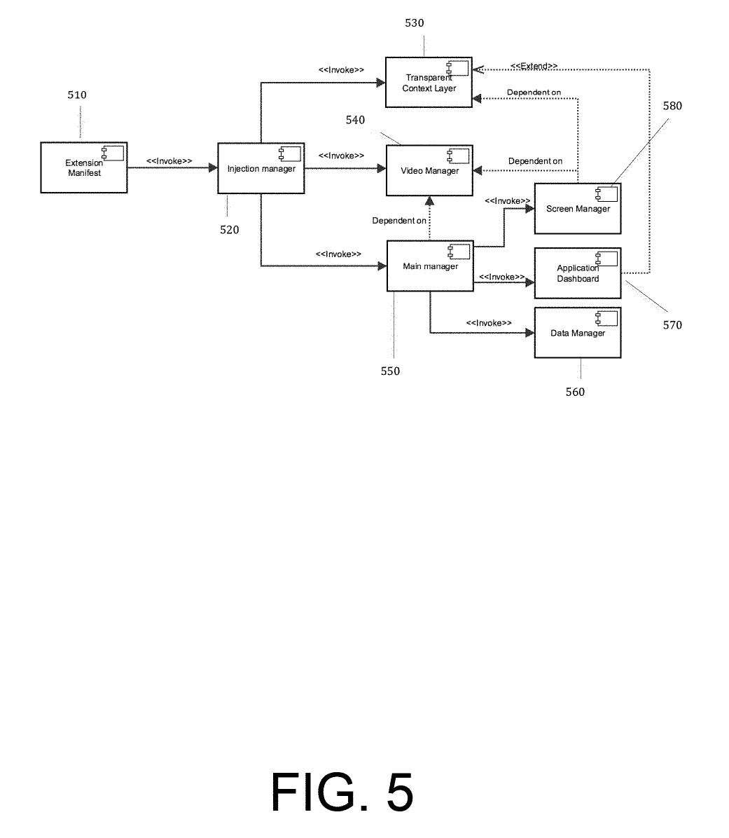

In some embodiments, the transparent screen 325, 350 is initially inserted as an empty DIV element with an application identified element ID. In some of these embodiments, an element ID of the transparent screen 325, 350 may be either hard-coded or determined by some set of rules to make the ID generation predictable. In these embodiments, the setting of the element ID is important so that the rest of the application can modify the DIV element of the page consistently. The injection component (later presented in FIG. 5 as 520) identifies the target objects 315, 345 in the DOM through the use of content managers (like a video manager, image manager, etc.) and attaches a transparent screen for the other components of the application to use. FIG. 3A and 3B's implementation of the TCL uses a combination of CSS styling attributes and the TCL's position within the DOM to place the TCL over the target video object 315 or 345. This way any mouse clicks directed to the example video frame can be processed by the TCL. This allows the application create new user content or to open existing user-authored content on a video object 315 or 345. However, to improve usability, the TCL may be porous, when not in use, so it does not intercept keyboard or mouse events and allows the user to use the web content as normal. The TCL abstracts the underlying content from the rest of the application so that user communications can be handled consistently across devices.

In some embodiments, for the transparent screen and its child nodes to appear in front of the target object, the application considers the order in which elements are stacked on the page. This stacking order refers to the way elements are placed on the page with regards to an imaginary Z-axis, where X and Y are the width and height of the page, and Z runs perpendicular to this plane. The z-index is a CSS attribute that helps determine these relative positions on the web page. An element that appears to be closer to the user, as in they appear to be rendered in front of other objects, has higher z-index than these other objects. FIG. 3A shows a Transparent Context Layer 325 with a z-index value higher than that of the video element 315. FIG. 3B shows a Transparent Context Layer 350 with a z-index value higher than that of the video's parent element 335.

For further context, according to the Mozilla Foundation, “stacking context is the three dimensional conceptualization of HTML elements along an imaginary z-axis relative to the user who is assumed to be facing the viewport or the webpage. HTML elements occupy this space in priority order based on element attributes.” See, e.g., https://developer.mozilla.org/en-US/docs/Web/CSS/CSS_Positioning/Understanding_z_index/The_stacking_context, which is incorporated herein by reference. Multiple stacking contexts may exist within the same page, and these stacking contexts can have other stacking contexts nested within them. The browser may determine the stacking order of the elements on the webpage through various different methods. One method is to compare the z-index values of elements that share the same stacking context. The browser places the elements with higher z-index values above the elements with lower z-index values. If these elements have children, those children's own stacking order is resolved within the context of their parent. As summarized by the Mozilla Foundation, “Each stacking context is self-contained: after the element's contents are stacked, the whole element is considered in the stacking order of the parent stacking context.” See, e.g., https://developer.mozilla.org/en-US/docs/Web/CSS/CSS_Positioning/Understanding_z_index/The_stacking_context, which is incorporated herein by reference. Therefore, if an element has a higher z-index than another element within the same stacking context, the first element will be placed over the second element and over any descendant elements of the second element, regardless of these descendant elements' own z-index values. Embodiments of the present invention may overlay on a screen by giving the TCL 325 a higher z-index than the object it is being attached to (e.g., video element 315), or if that does not work, then by placing the TCL 350 as a sibling of their parent context (e.g., video's parent node 335), and attempt to be at a higher z-index than that parent context (e.g., video's parent node 335). If the TCL 350 is at a higher z-index than the parent context (e.g., video's parent node 335), then it will be overlaid above that parent context's children as well as, the selected object (e.g., video element 345).

That is, when two sibling elements share the same stacking order, the one with the higher z-index will usually be rendered over the other. If one of these siblings has children, the children's stacking order may be determined by their z-index within the context of that element. For example, take four elements, element 1, element 2, element 3, and element 4, where element 1 and element 2 are siblings and element 3 and element 4 are siblings to each other and children to element 2. If element 1 has a higher z-index than element 2, it will appear above element 2. If element 3 has a higher z-index than element 4, it will appear above element 4. Since element 3 is a child to element 2, even if element 3 has a much higher z-index than element 1, element 3 will be rendered behind element 1. In this example, element 1 is rendered in front of all other elements, element 3 is rendered in front of element 4, and both element 3 and element 4 are rendered above element 2.

In embodiments of the present invention, if, for instance, element 4 is the selected object (e.g., video element 315), the TCL 325 can be attached as element 3 to be rendered in front of the video. However, in some embodiments, it might not be possible to render element 3 in front of element 4. For example, in some situations, browsers may have a maximum value for the z-index which they support. If element 4 has the highest possible z-index value, then it might not be possible to give element 3 a higher z-index than element 4, therefore element 3 might not be rendered in front of element 4. If this is the case, embodiments of the present invention would attach the TCL 350 as element 1, where the TCL is at a higher z-index than element 2 (video's parent node 335), which is the parent context to element 4 (e.g., video element 345). As above indicated, in this example, element 1 is supposed to be rendered in front of everything else. Stacking context in HTML and CSS can be much more complex than this example, but this example is one way the embodiment attaches a transparent screen to these native html elements.

Note, the stacking order in a web page can be determined by other things in addition to the z-index. The z-index is an attribute used to determine the order of elements within a given stacking context. Stacking context can be determined by many things (e.g., CSS ‘opacity’ value, CSS ‘position’ value), but the simplest and most predictable is the z-index. For this reason, in other embodiments, where websites may have their own different structures and styling methods in addition to modifying the z-index value of the transparent screen, also referred to as the TCL, (325, 350), the client 320 may further need to utilize other styling techniques as well as injecting the transparent screen in a different part of the DOM. In FIG. 3A, the TCL 325 is injected as a sibling to the video element 315; however, in FIG. 3B this same TCL 350 is instead injected as a sibling to the video parent node 335 of the video element 345. In FIG. 3B, the stacking context of the video element 345 is resolved within the stacking context of the video's parent node 335. Since the TCL 350 has a higher z-index than the video's parent node 335, then the TCL 350 is rendered in front of the video's parent node 335 and its children (e.g., the video element 345). Both of these examples achieve the same result of attaching the TCL onto the page over the video element. However, the option of choosing one implementation over another depends on the structure and behavior of the elements native to the Document Object Model (DOM) of a given page. These two examples only represent two variations of the process of injecting the TCL onto the DOM. Other variations in implementation may be used to fit a variety of different web pages.

Given this variety, the Transparent Context Layer also simplifies the organization of the page for the application to use. The application may use a simplified and uniform naming convention when selecting ID values for different transparent screens. By adding these simplified ‘labels’ the transparent screen masks the underlying web page's naming conventions from the rest of the application. For example, FIG. 3A has a video element with the class name ‘video-body’ 315, while the video element in FIG. 3B has the class name ‘video-object’ 345. The logic for finding the VIDEO element in both cases can be modularized and separated from the rest of the application logic; so that any updates required to handle the new document structure do not affect the normal application behavior. In addition, both DOMs have different structures and behaviors, which required the application to attach the TCL differently. As the variety of different sites supported by the present invention increases, the logic for determining the methods of injection and interaction with the underlying content becomes more diverse. The TCL and the injection manager (later show in FIG. 5 as 520) abstract these differences from the rest of the application making the display and input mechanism simpler. There are different methods to identify the video element in the example above.

In embodiments, the methods by which the content managers detect target content vary. In some embodiments, the rules are hard-coded as a list of verified IDs and CLASS names that the application may use to quickly extract target objects. Using these rules, combined with a list of vetted URIs, the application may quickly identify objects of interest within a limited range of sites. In these embodiments, the injection manager (later show in FIG. 5 as 520) may also include a hard-coded set of rules for attaching the transparent screens as to prevent conflicts with the styling of the website and its own scripts. In some embodiments, this process is extended by defining more flexible rules for detecting target objects, such as targeting objects by element tag type (such as VIDEO, IMG, etc.), as well as setting more robust styling rules to prevent bugs and conflicts.

### Using the Transparent Context Layer

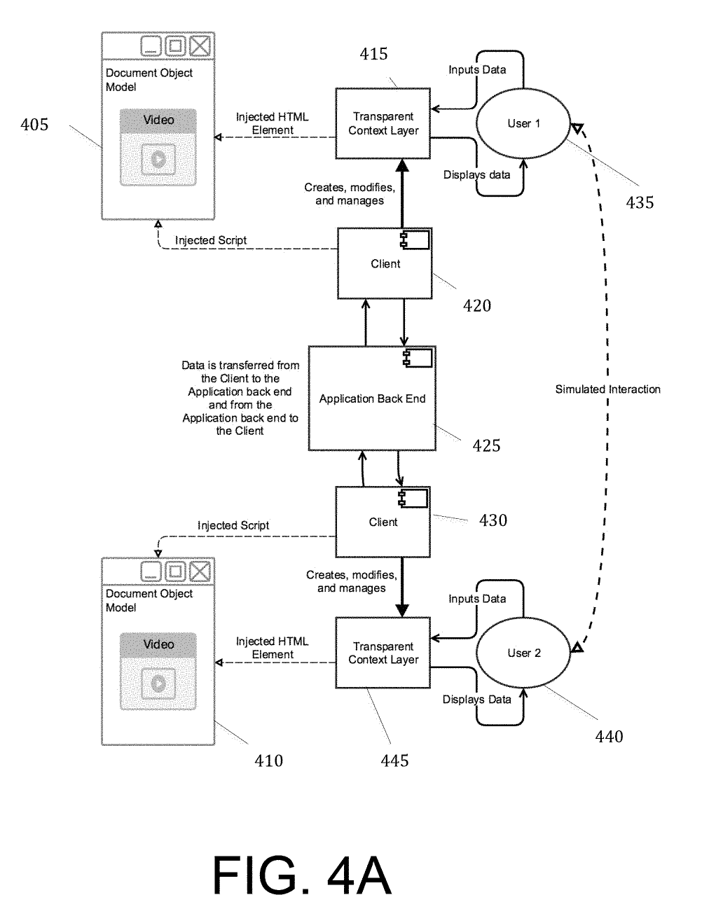

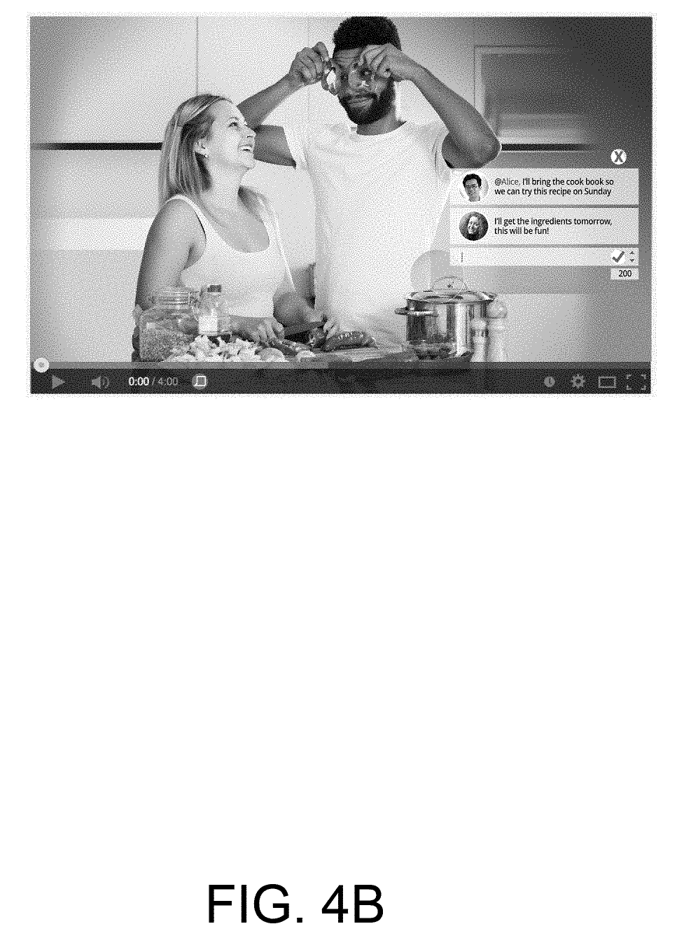

FIG. 4A is a block diagram depicting the Transparent Context Layer (TCL) overlaid onto online content being viewed by a user in embodiments of the present invention. FIG. 4A further depicts the components that allow two or more users 435, 440 to communicate in embodiments of the present invention. The TCL enables the user 435, 440 to interactively communicate (input/display data) regarding the online content over the same communication channel that the user receives the online content. In the embodiment of FIG. 4A, the user 435, 440 views/watches on a display device, online video content received from a communication network (e.g., the Internet). The user 435, 440 may access the video content by selecting a Universal Resource Identifier (URI) via a web client (web browser) configured on the user's device, which locates and displays the webpage containing the desired video content on the user's device. In other embodiments, the content may include images, audio, or any other online content, without limitation, that may be received over a communications network. In some embodiments, content may be accessed by non-browser applications.

In the embodiment as shown in FIG. 4A, a system is provided to facilitate communications between two users 435, 440. Communication between the two users (User 1 435 and User 2 440) visually simulates the interaction as if it were being achieved through the web content being consumed. The Transparent Context Layer (TCL) 415, 445 presented to a respective user 435, 440 simulates the attachment of metadata to the underlying content objects on the page. For example, by injecting an HTML element in the DOM of the respective displayed video content 405, 410. In regard to the video in the embodiment of FIG. 4A, this TCL would simulate the placement of user-generated content directly on the video frame itself allowing a possible user to consume this content. This TCL may also act as an input device for the client application 420, 430, allowing for the collection of user input directly over the content being consumed. This allows a user 435, 440 to generate new content over the example video frame. This TCL and all of the application's functionality are handled by a client application 420, 430 on the user's device, including via injected script at the DOM 405, 410. The clients 420, 430 create, modify, and manage its respective TCL. Communication between clients 420, 430 is handled by an application back end component 425 that stores, processes, and provides all clients with user-generated metadata and content. For example, user-generated data is transferred between the clients 420, 430 to and through the application back end component 425.

Once the application 420, 430 is initiated, it runs its main manager script, which manages all other managers and maintains the application's state within the page. In some embodiments, the main manager script may handle data managers, content managers, screen managers, and utility modules. These components of the application 420, 430 are disclosed in more detail in FIG. 5 that follows. The application may function by requesting information from a server (application back end) 425 based on the current page's URI. The server 425 provides to the applications 420, 430 executing on the user device any metadata associated with that page that the user 435, 440 has access to as defined by a subscription model. In other embodiments, different models may be used for storing, defining, and communicating data in the application back end 425, including the model used for XMPP and other push notification frameworks. The server (application back end component) 425 and the application client 420, 430 may need to interact with different variations, iterations, or implementations of the other, so it may be important for the application to process the server data to fit its own requirements. For example, the application 420, 430 may maintain an active list of messages in an opened conversation and update the conversation object when a new message is located. This update functionality and its triggers may be defined and executed by one of the data managers in the application.

As shown in FIG. 4A, two or more users 435, 440 may share information with each other on a portion of the video content via visually marking a transparent screen (transparent context layer 415, 445) presented on their display devices. This marked portion and shared information may be communicated to a user over the same network channel (Internet) that the user receives the video content. As the user 435 views the video content, the client 420 may indicate the marked portion of the video content on the transparent screen 415 presented on the user's display device. As shown in FIG. 4A, the application 420 also displays (via the transparent context layer 415) a communication component (e.g., online video messenger or social network channel) that presents the shared information regarding the marked portion of the video content. The user may further select the transparent screen to indicate (mark) another portion of the video content and provide/share information on this marked portion to continue interactive communication with the one or more other users regarding the video content. In other embodiments, the content may be pushed via mobile, email, social media, and other automated communication method without limitation.

### Consuming User-Authored Content

In particular, FIG. 4A illustrates the communication between users 435, 440 that creates the simulated user experiences of the interactive communication platform. FIG. 4A illustrates consumption using web-based (HTML) video content (405, 410), however, other embodiments may include other forms of consumed content including, without limitation, any one or more of: embedded, non-HTML, video player/stream services, kindle services, non-video content, and any other content. In FIG. 4A, a loaded page of video content is displayed to user 1 435 on the display device of user 1. The loaded page is formatted as a Document Object Model (DOM) 405. The client component 420 in FIG. 4A executing on the display device of user 1 represents the combined effort of the manager components of the application 420 (later shown in FIG. 5). This client component 420 identifies shareable objects (including video content) in the DOM tree 405. The client component 420 further generates and attaches Transparent Context Layers (TCLs) 415 to the DOM tree 405, which may be used as input devices, as well as, to display the new data elements added to the DOM tree 405 that reference the identified object (for example in-video conversations that reference a ball in a video frame). In addition, a dashboard displays error messages for the user 435 and may be used to enhance existing element features. For example, in some embodiments, a video with user-generated content may have its time line colors modified in such a way as to visually show the user where content is located within the video timeline. Other embodiments may include video searching functionality, video browse function, and other content related interactive functionality.

Once all the application components of the application 420 are initialized, a data manager of the application 420 may request, from an application server component 425 of the platform, all of the data related to the page content accessible to the user 435. When this data is received, a screen manager of the application 420 renders the metadata through the transparent screens 415 attached to the target content objects in a passive and unobtrusive form. At this stage of the example method, the application 420 is configured to notify the user 435 of the available additional content without interrupting the user's regular experience of viewing the online content. For example, in some embodiments, the application 420 may render received additional content as small markers (bubbles, dots, etc.) on the frame as the user 435 hovers his/her mouse over the video content. This gives the user 435 easy access to the additional data by quickly showing the user 435 what parts and items in the video have additional content, while still allowing the user 435 to view the video without any interruptions in a human readable form for users to enjoy. The user 435 may then select one of these small markers on the video content, which corresponds to additional information authored by them or another user to open and fully access it. In the video example, the selection of a marker may pause the video, and open the in-video conversation associated to the marker that was selected. These in-video conversations are a collection of messages authored by one or more users that are associated to a specific mark. These in-video conversations (FIG. 4B) are one example of a human readable representation of the shared content, but the representation may take other forms in other embodiments. For example, some embodiments may display a product found in the content and its purchase information in such a way as to facilitate the purchase of said product. These embodiments may as well include mechanisms to identify these products and enrich the content with the sales and pricing data, live pricing, promotional materials, and other such purchase related information without limit.

The platform depicted in FIG. 4A also includes one or more servers as part of the application back end component 425 to manage and store user-generated content and relational data of target objects, this data includes video ids, URIs, coordinate and time data, etc. One or more database users may be used to store data for and support the main platform server's services. Data stored may include user data, relational data as described above, images, video, audio, text, and other forms of user-generated and non-user-generated content. This information may then be combined and organized for processing and communicating the page content between users and the relational connection between conceptual objects, ideas, products, messages, people, etc. across the web. The example screenshot in FIG. 4B shows text information being displayed over a video via the platform of FIG. 4A.

### Interactive Communication Platform

FIG. 5 is an example component diagram depicting components of the interactive communication platform that enable a user to interactively communicate using the TCL shown in FIG. 4A. Components of the platform (e.g., browser plugin, non-browser application, etc.) executing on a display device, or other device (processor) coupled to the display device, are provided to facilitate and enhance sharing of the content in several ways. The example is composed of an extension manifest 510, which is usually a requirement for some browsers to run a given plugin or extension. As well as an injection manager 520, a video manager 540, a main manager 550 (holds all state data and instances after the application is initiated), a screen manager 580, a data manager 560, and an application dashboard 570. The main manager 550 may also be referred to as the main manager script 550. The content managers define the objects the application is capable of interacting with by specifically mapping to an element type or situation. For example, in some embodiments, a video manager 540 is a content manager designed to identify a video element object, retrieve the video object from the DOM, examine its styling attributes, as well as directly manipulate the element (if applicable). Once the targeted object is identified by its corresponding content manager, a Transparent Context Layer 530 (embodiments of which are shown as 415 and 445 in FIG. 4A) in the form of an HTML element (most commonly a division or section element) is attached (as exemplified in FIGS. 3A and 3B as 325 and 350 respectively) to provide the application with a clean workspace on the DOM to function. Note, in other embodiments, the TCL may be in the form of a non-browser (non-HTML) version, such as a version executable on an Android application or any other operating system application without limitation. This TCL acts as a container on the DOM structure onto which the application may attach any additional HTML elements (or non-html objects in other embodiments). Additionally, the application may attach event listeners to the transparent screen so that it may be used by the application as an input receptor, through which a user may directly select the content that the user wants to share. In some embodiments, this HTML element is invisible to the user and only serves as a foundation for the functionality of the application. As well, the components in FIG. 5 can be generalized further in other variations of the embodiment to suite different additional features as well as software and hardware environments. The present example displays one way to implement the core features of the present invention.

### Creating New User-Authored Content

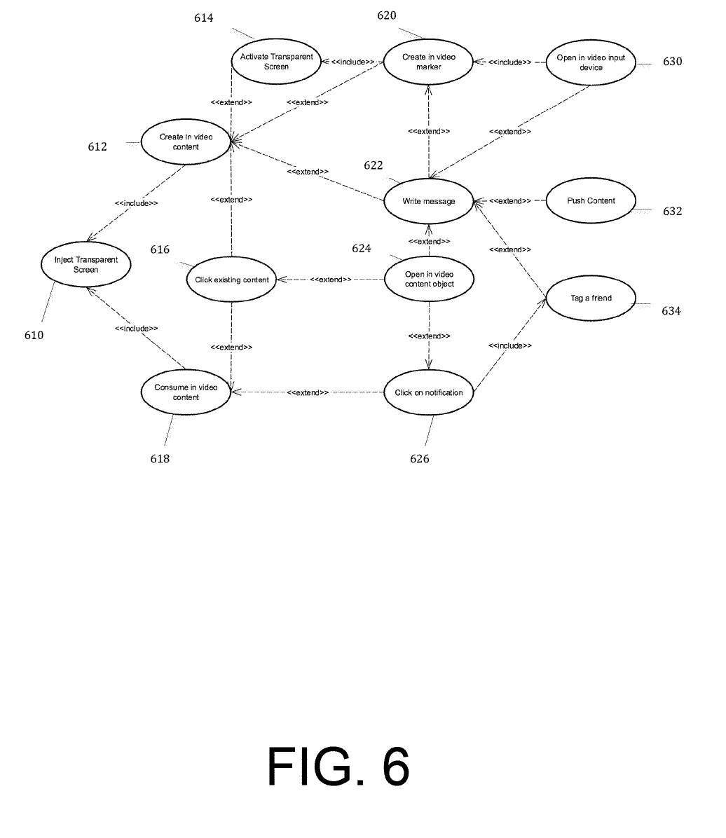

FIG. 6 is a use case diagram that illustrates how a user may create and consume content. In other use cases, the content may be created by a bot, automated system, or other automatic way. This is how some embodiments may facilitate user interactions through the content and communication between different users as shown in FIGS. 2 and 4A-4B. Allowing the user to create new content requires that the application have injected a Transparent Context Layer (TCL) 530 onto the content. This TCL 530 enables the user to indicate (mark) a portion of the video content and share information on the marked portion of the video content with one or more other users. When an in-video marker is created the application then displays an in-video input device (e.g., online video messenger or social network channel) for the user to author and share information on the marked portion of the video content with one or more other users. The marked portion and authored information may be communicated to the one or more other users over the same network channel as the video content.

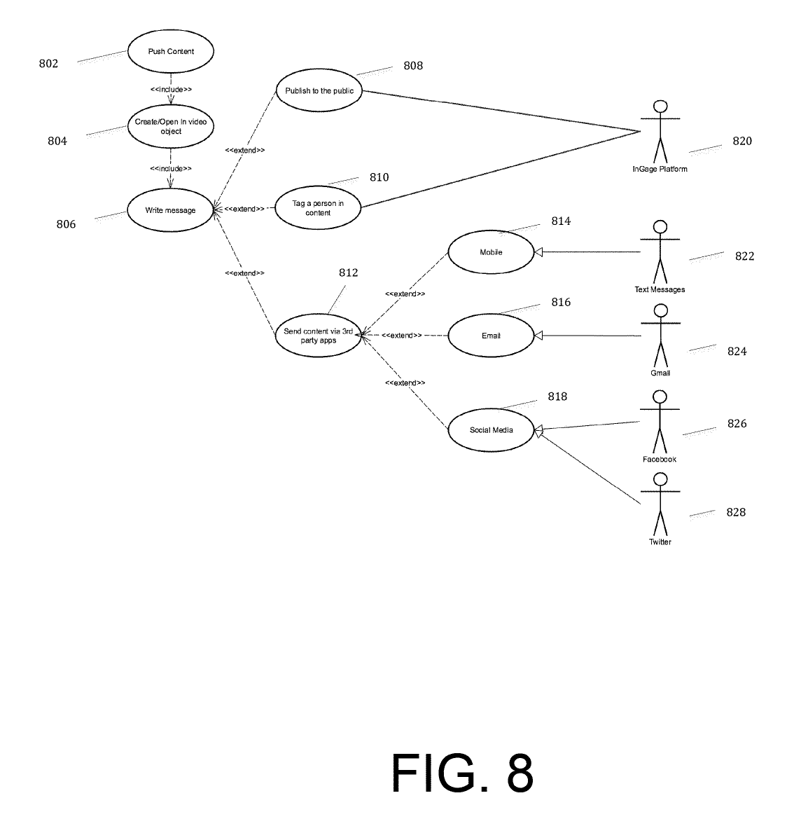

The use case methods of FIG. 6 illustrate that for a user to author content (step 612), a transparent screen must first be injected (step 610) into the existing video content. After this, the user may activate the transparent screen (step 614), and then the user may create an in-video marker (step 620) at the present content. With the marker in place, an in-video input device will open (step 630) and provide the user with a method to write a message (step 622). When writing the message (step 622) the user may tag a friend, at step 634, and/or push the content to others at step 632 (as further explained in FIG. 8).

For the purpose of creating new in-video content at step 612, such as conversation objects, the application may initialize a number of dashboard 570 module instances equal to the number of Transparent Context Layers 325, 350 on the Document Object Model (DOM) 305, which each provide and manage user interaction with the interactive communication system. For example, in a video, the dashboard 570 may be added below the timeline, next to the player controls. Each dashboard 570 takes the form of a transparent DIV with buttons, a display box, and other such graphical input widgets. The dashboard 570 of FIG. 5 may extend the functionality of the TCL by adding buttons that provide the user with additional functionality and make the process of marking objects in-videos much simpler. Further, in some embodiments, the dashboard 570 messenger button is an example of a button that extends the functionality of the TCL.

In some embodiments, when a user wants to add a message to a video, the user may first click on the messenger button from within the dashboard 570, which pauses the video and sets the state of the TCL to ‘Active’ (step 614) allowing any click the user performs on the frame to be recorded. By doing this, the application may create a mark (step 620) at this location on the transparent screen, which provides an input box, or other input widget (step 630), for the user to write their message (step 622). In some embodiments the user may then be able to visually verify that the mark is correct with some additional features of the input widget or the dashboard. After completing the message, the user may submit the message and continue watching as normal. In these embodiments, if the dashboard 570 messenger button is clicked while the TCL is in an ‘Active’ state, the TCL may cancel this state and return the user to their normal video viewing experience. Additionally, in these embodiments, as the user is watching, clicking on the frame does not trigger the application unless the user specifically clicks on an existing mark on the video or clicks on the messenger button (therefore setting the TCL to an ‘Active’ state 614) before clicking on the frame. This is to provide users with their normal, unobstructed experience. In other embodiments, the dashboard 570 may include different or additional functionality. In some embodiments, the functionality depends on the type of sharing, type of element, and need of the application. The dashboard 570 may also be used to directly communicate with the user, such as to announce an error or provide a success message. Note, in other embodiments, the TCL may be activated without the use of the dashboard 570, such as after the user hovers over the video, holding down a click, a key binding, and the like.

In some embodiments, after the mark is created (in step 620), then, the sending user is allowed to add additional information/input in the form of a message (in step 622). This message is tied to the object in the video by its mark. In these embodiments, the mark does not literally link to the object in the video, the mark simply gives the user a visual queue that the message and the object are related. With the time value stored for the frame, the mark (and associated message) may be limited to only appear at the proper time in the video, further tying the associated message to the object conceptually. In some embodiments, by storing multiple time and coordinate values, the mark may later be used for the application to traverse the transparent screen in the same way as the content object in the video, thereby, tracking the content object. In some embodiments, such a tracking mechanism may be performed by the user through tools on the dashboard 570 that allow the user to mark points in time and space on the video, through other in-video input devices, or through other automated ways. In example embodiments, the metadata of the marked points is stored on a server of the platform. When any user visits a page, the user may send a request to the server (application back end 425) for the metadata accessible to the user for that page.

As an example, when a user is watching a video online, the user may find an object within the video that is of particular interest. The user may use the dashboard 570 messenger button to pause the video and activate the transparent screen at step 614. Although the user believes that he/she is clicking on the video when they click the frame, the click event is performed on the transparent screen. In some embodiments, (e.g., In the case of a video), where time is also a variable to consider, the video manager 540 component of the application may provide a current time value for the video frame. The client (application) records this current time value to allow other applications to navigate to the same frame, as well as the normalized x and y coordinate values for the click event. In some embodiments, with the point (0,0) being located at the top left corner of the screen, the Y-axis running south in increasing values, and the X axis running right in increasing values, the application may generate an absolute position for the click. The coordinates of this absolute position are then converted by the application to decimal values between 0 and 1, where 1 is the right most or bottom most edge of the target object, and 0 is the top most or left most value. The application performs this conversion to account for future changes in aspect ratio or video frame size by taking the position value and dividing by the height (for the y value) or the width (for the x value). In this way, if the height and width values of the video change, the application can still pinpoint the location (mark) by multiplying the normalized coordinates by the new height and width values of the video.

### Sharing Content Using Notification Objects

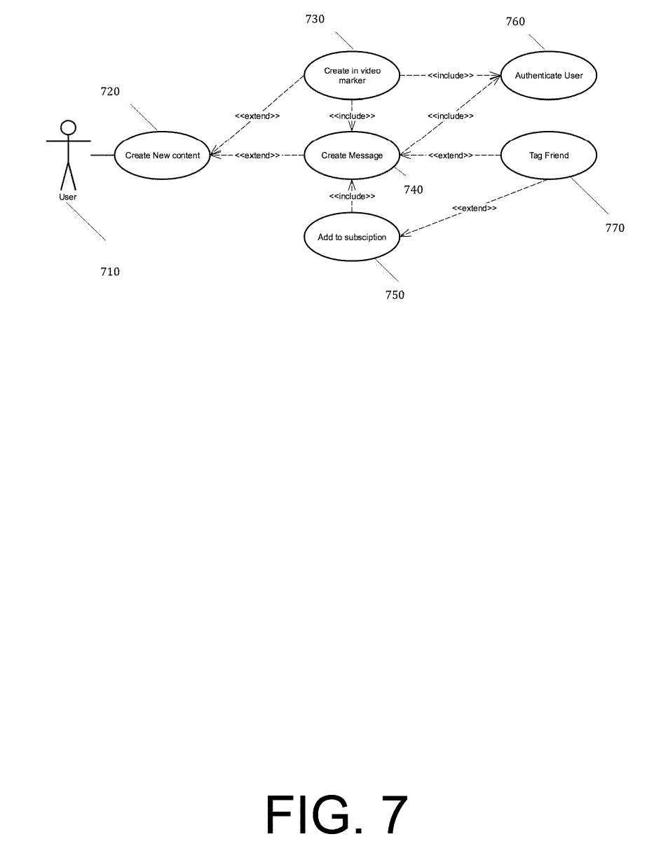

Further, FIG. 6 also illustrates the process by which in-video content can be consumed once a receiving user has been tagged in an object, and receives a notification object for the shared content. A sending user may tag a friend at step 634 by providing the receiving user's name (or other form of identifier, such as a username) when writing their message at step 622. The method through which the sending user may provide a friend's name (or identifier) may vary. Some examples may include a method which provides a direct ‘to’ field in the input device, and another that uses some form of special character as an identifier within the message (e.g., ‘@’). Once a user is tagged in step 634, the application back end 425 will process the request (the process which is shown later in FIG. 7). This will allow the application back end 425 to provide the receiving user with a notification object, which a receiving user may then click on (step 626) to open an in-video object (step 624).

In some embodiments, a notification objects contain the information that makes up an in-video object as well as the last message associated to that object. This way a user may be ‘notified’ of a new message attached to an in-video object they are subscribed to. Clicking on this notification (step 626) opens the associated in-video object (step 624), where the user can click existing content (step 616) and consume in video content (step 618). In example embodiments, notifications and access to metadata are defined by a subscription model, such that a user may subscribe or be subscribed (via tagging) to content, and, therefore, be given access to and be notified about said content. In some embodiments, like in FIG. 7, when a first user shares content with a second user, the first user simply gives access to the authored content to the second user. In the subscription model embodiments, the application of the receiving user may normally check the server for new activity on the in-video objects they are subscribed to. For example, the application may hold a list of in-video conversations (conversations are an example of an in-video object) that the user is participating in or has been tagged in as subscriptions. This list is organized in chronological order by the date of the last message found on the conversation. In this way, a conversation from last week with a message from today is higher on the list than a conversation from yesterday with a message from yesterday. The in-video conversation list on the server is then compared to the one currently stored on the client's memory. If there is a difference, the application may trigger an alert to the user for any new conversations not previously on the list or any change in the order. If older conversations are higher in the list than they used to be, then the application may determine that a new message was added to that conversation for the user to view.

Items in this in-video conversation list may contain information about the in-video object they represent. In embodiments, to visit the content, the user first selects the desired conversation that the user wants to view (by clicking on the notification object as in step 626). The application executing on the user's device receives the content's URI, type, application ID, and activation options. These are available to the application for all of the subscribed content being listed to the user. Selecting one stores the mentioned data for the particular target and redirects the user to the proper page. Once there, the application downloads all available metadata for the page as described before. Once the data is received the application then searches the data for the specifically selected content and activates the selected content based on the data options. For example, in regard to an in-video conversation, the application may pause the video and set the current time of the video to that stored on the notification object. The application may, next, open a conversation object (as in step 624) on the video (at the exact frame that was shared). The user may, then, respond to the conversation through the same rendered object.

In some embodiments, the content that a user may add to a video or other form of online pre-existing content can be extended to cover a wide field of possibilities. However, most user-authored content variations may share certain distinguishing features with each other. For example, a circle shaped DIV with its center at a mark's coordinate location helps focus a user's attention on the marked object. Other objects may then form visual attachments to said object to show users that the content they contain is to be associated with the object being marked by said circular DIV. In this case, the aforementioned DIV acts as a focusing agent to allow an object to be marked and having user-authored content associated with it, while still keeping it visible to the consuming user. A more robust visual agent might include a n-sided polygon surface that outlines the desired object.

The present embodiment of the application has been illustratively described to use text-based user-authored content to display to its users. However, embodiments of the present invention are not limited to text-based user-authored content, but may expand the allowed types of metadata to further include any other forms of user-authored content, without limitation. This includes, but it is not limited to, audio, video, images, widgets, among other forms of content. These forms of content can be injected into the TCL 530 via the screen manager 580 in the same way in-video conversations, for example, are described to be displayed. The example screenshot in FIG. 4B, not only shows text information being displayed over a video, but also includes the profile images of the users conversing. This is an example of an image object being placed over the video content. Other forms of content may follow this example, or require a different human readable form to further improve the content's visibility. As the content shared through the application evolves in its variety, embodiments of the invention may also adapt to encompass these new forms of content.

### Sharing Non-Video Content

The types of websites and content through which users can interact with embodiments of the present invention are numerous. In embodiments, a content manager is a script (initiated by the Injection Manager 520) that masks the HTML element functionality for specific elements from the rest of the application. For example, the video manager 540 may be a content manager that makes manipulating and examining a video object simpler. This is necessary because a video object may take the form of an HTML 5 VIDEO element or a flash object or such. These elements/objects have very similar functionality, but the function calls and attributes associated with each are accessed differently. In embodiments, rather than the rest of the application carrying unnecessary logic for identifying which type a video object in a page is, then use the proper calls, the video managers 540 abstract the information and provide a single set of methods. For example, IMG elements have different functionality and methods, so these elements may have their own content managers. A goal in this respect is to simplify the application code, and make the transparent screen functionality as element agnostic as possible.

This allows embodiments to provide the same functionality described by FIG. 2, on any form of content on the web. By extending the functionality of the Injection manager 520 and developing the appropriate Content manager, the embodiment may attach a Transparent Content Layer to different types of HTML elements and web objects. This may include, but is not limited to, images, articles, GIFs, among others forms of content. Once a TCL is attached to these objects, the content creation, pushing, and consumption mechanisms shown by other embodiments can be extended to cover these forms of content as well, since any interactions with the underlying content will be handled by the appropriate Content managers.

### Creating In-Video User-Authored Content

FIG. 7 is a use case diagram illustrating the process by which the application back end component 425 processes and stores new user-authored content. In FIG. 7, a user 710 initiates the creation of content at step 720. To do so, the user 710, creates an in-video marker at step 730. In embodiments, the server may store the in-video marker information (e.g., coordinates, time values, video URI, video ID, etc.) as well as the corresponding message, people subscribed to the associated object, and such. The in-video marker has a reference to the page it was created on as well as to the mapped object in the page it is associated to. For example, on a video page, the video ID and URI are enough to identify the main video being played. In addition to this information, in this example, the in-video marker also stores the coordinate location and the time reference of itself on the video.

The user then creates a message based on a created video marker of the video content at step 740. The platform may store the associated message as well. Embodiments may display text-based metadata over video content, therefore to make sure in-video markers are relevant, some embodiments may limit the creation of in-video markers to include (or require) some form of metadata (e.g., a message). The combination of an in-video marker and its associated metadata is an in-video object. For example, the in-video conversation shown in FIG. 4B, is an in-video object composed of an in-video marker as well as a list of one or more messages corresponding to the marker. Note, in other embodiments, the metadata may include non-text content, such as products, images, and the like.

The user 710, then, tags a friend in regard to sharing the message at step 770, which first requires verifying the friend as an authorized user of the platform at step 760. However, in other embodiments, the user may tag a friend who is not a user on the platform. In the embodiment of FIG. 7, the tagged friend is then, at step 750, added to the subscription for the in-video object giving the tagged friend access to the user-generated content (e.g., messages associated to the in-video object) as well as allowing for them to be notified of the existence of the content and its changes (e.g., new messages). Note, in the case of public in-video markers, all users may access these markers when they visit their associated URI page. However, this may not necessarily subscribe the users to the existing marker, and, therefore, they would not receive notification alerts when new messages are added.

Further, if a user 710 replies to a message thread on a public in-video object that the user located in this way, the user may be subscribed to the in-video object since the user may now be an active participant in the conversation. Further, when a user visits a page, the server provides the application with all of the user-authored content available for that page that is accessible to the user. Notification alerts function when an application on a user's device requests the subscription list for the user. The subscription list may be ordered in chronological order by the date of the last message on it. The application then compares to its own list, the data of its last check, among other things to verify whether an alert for a new message is necessary or not. The comparison makes the application fully asynchronous since all actions are performed by an application at its earliest availability without checking with other applications (e.g., on other user devices).

In some embodiments, a few characteristics are present regarding the nature of the content within the object selected on a page. First, the content remains unchanged (persistent) for all time. For example, a video on a page of snow falling will always be a video of snow falling, the video content itself is assumed to be unmodified after being uploaded. In embodiments including dynamic websites, where videos might constantly change, the application must store certain metadata about the content itself to distinguish between the different videos. Since the object ID is usually tied to the purpose of the element, and not to the content itself, using the object ID is not always useful for these dynamic websites. Depending on the type of content though, there are different techniques that are used in different embodiments. For a video hosting site, the video ID provided by the owner of the site may be robustly used by the application. These video IDs are usually parameter values in the URI of a site. In other embodiments, regardless of the purposes of the website, the content is unchanging so through a combination of the page URI and the object positioning and type, the application may confidently identify content online.

### Pushing Content to Other Users

FIG. 8 is a use case diagram that illustrates the process of pushing content to other users. In FIG. 8, the method of pushing of content to other people, both user and non-user, begins at step 802. The pushing method includes, at step 804, the creation or the existence of an in-video object and, at step 806, the writing of a message. The method then pushes the written message to one or more other people using various options. The method may push the written message by, at step 808, publishing the message to the public. The published message is then received by other users of the platform, at step 820. The method may also push the written message by, at step 810, by tagging a particular user of the platform. The written message is then received by the tagged user of the platform, at step 820. The method may further push written messages by, at step 812 sending the content to third-party applications. In FIG. 8, the written messages are pushed to a third-party mobile application (step 814), such as, to a text messaging application as a text message (step 822). The written messages are also pushed to a third-party email application (step 816), for example, as an email being sent to a user's email address (step 824). The written messages are also pushed to a third-party social media application (step 818), which forwards the messages to a user as Facebook postings (step 826) and/or Twitter postings (step 828).

In this way, the pushing method 802 extends the functionality of writing messages and generating content by giving said content a target audience. In some embodiments, the user may provide additional information to share with another user regarding the portion of video content, and the provided information may be placed in the in-video object for communication to another user as part of the video content.

As shown in FIG. 8, in some embodiments, a message is required to push content to another user because the process by which the content is shared is by tagging an individual (step 810). This tagging mechanism 810 involves providing the username of a user on the platform. The tagging a friend extends the subscription functionality as described in FIG. 7. Once a user is subscribed to the content, their client application may receive notifications about the given content. The notification may be selected by the receiving user (step 626), which triggers a process that directly renders the additional content on the transparent screen, attached to the intended target object in its active mode (step 624). For example, an in-video conversation may be shown to the user as open, and the video may be paused at the intended time frame for the user to consume the additional content and possibly reply (as shown by the screenshot in FIG. 4B).

As shown in FIG. 8, another possible embodiment of pushing content involves sharing the content as public (step 808). Users may still be subscribed or tagged on Public content, and those users will receive notifications as normal. However, users who are not tagged or subscribed will not receive notifications for said content, therefore they will only see the content when they visit the page where the content originated.

As shown in FIG. 8, another possible embodiment of pushing content involves pushing content to third party applications (step 812). This allows a user to share content with other users and people who are not using the platform. In some embodiments, the application would allow users to provide an email address (step 816). This would be handled by the application back end 425, and in some variations the receiving individual would receive an email with both the content authored by the sending user as well as the content being shared in some form. This may include, but it is not limited to, a Universal Resource Identifier to the content's page, an image of the content, or the embedded content itself (e.g., on other third-party sites). A user receiving this email message, that has the application installed, may then proceed to consume the content as if it were a normal notification, by being redirected directly to the content. On the other hand, in some embodiments, a person without the application installed may be redirected to a webpage with the shared content (e.g., shared DOM element), the application, and the user-authored content all embedded.

In some embodiments, if a phone number is provided (step 814), the content would be handled by the application back end 425, and in some variations the receiving individual would receive a text message (step 822) with both the content authored by the sending user as well as the content being shared in some form. This may include, but it is not limited to, a Universal Resource Identifier to the content's page, an image of the content, or the embedded content itself. A user receiving this text message, that has a mobile version of the application installed, may then proceed to consume the content as if it were a normal notification, by being redirected directly to the content. On the other hand, in some embodiments, a person without the application installed may be redirected to a webpage with the shared content, the application, and the user-authored content all embedded.

FIG. 8 also includes a situation in which content is shared through social media (step 818). This is accomplished by using the APIs provided by different social media providers. A user may log into the application, and provide access to the application to send messages and create posts on their behalf. With these permissions in place, the user would similarly provide information to the application, in some embodiments by selecting a social media option for example, and the application back end 425 would process the request. In the case where the user wishes to post content to the public for example, the application would create a social medial post with the content authored by the sending user as well as the content being shared in some form. This may include, but it is not limited to, a Universal Resource Identifier to the content's page, an image of the content, or the embedded content itself. Users that decide to click on this post, that has the application installed, may then proceed to consume the content as if it were a normal notification, by being redirected directly to the content. On the other hand, in some embodiments, a person without the application installed may be redirected to a webpage with the shared content, the application, and the user-authored content all embedded.

FIG. 8 only illustrates some of the possible variations for sharing content, and pushing content to users from within and without the platform. The extendibility of the pushing functionality is only limited by the available APIs, services, and available social media sites.

### Displaying Content

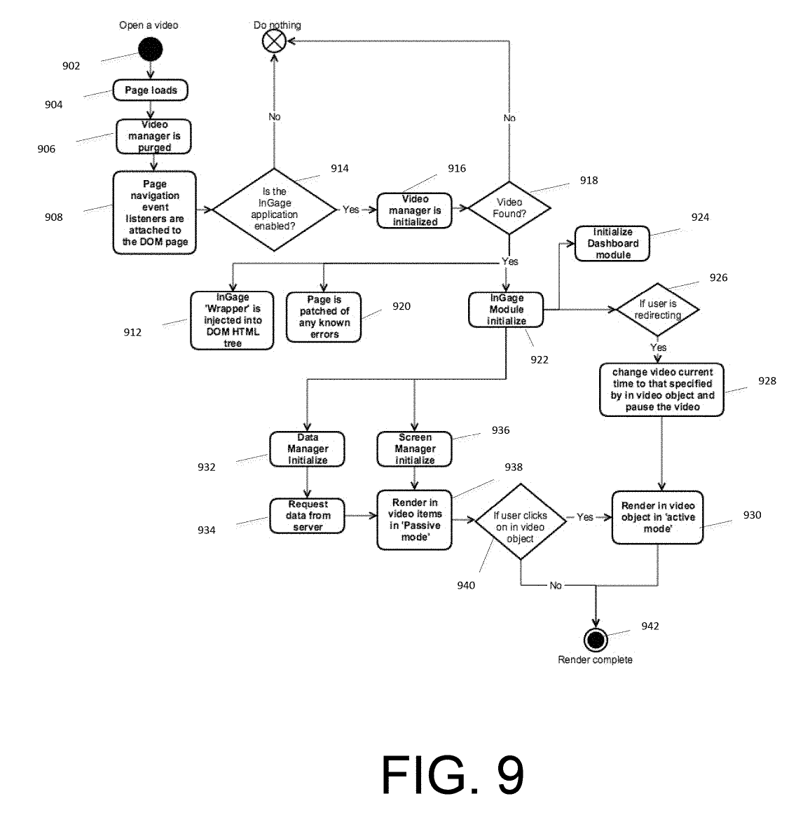

FIG. 9 is a flow diagram depicting an example method of displaying a video content page in the interactive communication platform of FIG. 4A. This example method can be adapted to fit different application devices or environments, FIG. 9 in particular shows the process by which a browser plugin on an application device might implement FIG. 4A. FIG. 9 includes an example method by which an instance of the application may be initiated and the Transparent Context Layer maybe created and injected in embodiments of the present invention. FIG. 9 also depicts a use case when the user opens the TCL in-video content.

The example method begins by the user, at step 902, opening a video, such as by selecting a website link or file, through a browser application executing on the device of the user. In response, at step 904, the browser application loads/renders the page (webpage) containing content of the video in the respective browser display. Once the page is loaded (step 904), the browser application loads an instance of the application (online content communication engine) of the interactive communication platform, which enables users of the client devices to interactively communicate regarding the page content. In step 906, the application's injection manager 520 looks for instances of the main manager component (550 of FIG. 5), as well as for any content managers that might still be active from prior loaded webpages (e.g., video managers (540). These content managers are terminated, and any associated transparent screens removed from the DOM. In most cases, termination is not necessary, as the page is being freshly loaded and, therefore, the manager scripts will be running on the page for the first time. However, some sites attempt to reduce latency in loading pages by only loading necessary changes to the DOM, instead of requesting new a DOM, because of this, the application cannot rely on its own state being purged when a new page is loaded. The application may therefore attach event listeners on the DOM, in step 908, to detect these forms of partial page loads. Using the attached listener, the application tries to fully initialize itself on the page. If an instance of the application already exists in the page, a navigation trigger is executed, in which the application purges all previous instance information to remove possible state contamination from any previously loaded pages.

After the purging is complete (if the purge is necessary) or if no purge is necessary, the application proceeds to attempt to initialize itself by checking its own enabled state, at step 914, to determine whether to initiate/enable (or terminate) based on accessing the user's preference settings. This is done after purging the application's content from the page in order to prevent application objects from being injected into the DOM and being left alone in a zombie-like state (as in, without any functionality, purpose, or way for the to remove them). If the application then initializes itself, the injection manager 520 will proceed to initiate the content managers (video manager 540, etc. of FIG. 5). These content managers determine whether there is content to share on the page or not. Specifically as shown in FIG. 9, the application, at step 916, initializes the video manager 540 and checks, at step 918, to locate content (a video). If no content is located, for example, if the application only includes the video manager 540 and no video is located, the application terminates itself. Otherwise, if a content manager locates target content, the injection manager 520, at step 922, initializes the main manager 550 (referred to as InGage Module in FIG. 9). The content manager then provides the content to the injection manager 520 (e.g., as an HTML object in JavaScript) so that the injection manager 520 may attach the transparent context layer 530 (referred to as the InGage Wrapper in 912) to said content. The application also initializes the dashboard 570 module at step 924. The manager script (main manager 550) then initiates, at step 936, the screen managers 580 associated with those transparent context layers 530. At step 932, the application, then initializes the data manager 560. The data manager 560, at step 934, may then request data from the server (application back end 425). Further, at step 920, the application patches the page of any known errors. At step 938, the application, with the data manager 560 and the screen manager 580 initiated, may then render the in-video items in ‘passive mode’.

Note, screen manager 580 uses the appropriate content manager, such as the video manager 540 of FIG. 5 to retrieve the dimensions of the DOM element to which the manager is attached. With these dimensions, the screen manager 580 modifies the styling of the attached transparent context layer 530, using its element ID to identify and extract the element from the DOM, so that the transparent screen matches the dimensions of the element it is attached to. As shown in FIG. 3A and 3B, with these values, the attached transparent screen may be molded to match the target object's width and height values. Once the transparent screen is in place, the screen manager 580 may also attach additional objects over the video element through the transparent screen. This is used to both display user-generated content and to provide users with input mechanisms such as text boxes and a series of event listeners (e.g., click listeners).

Returning to the method depicted in FIG. 9, the user at step 940 clicks on an in-video object, which renders the in-video object in ‘active mode’ at step 930. In addition, at step 926, if the user is otherwise being redirected to the in-video object (e.g., via a notification click 626), at step 926, then, at step 928, the application changes the video current time to the specified time in the in-video object and pauses the video. After the application changes the time, the application also, at step 930, renders the in-video object in active mode. In ‘active mode’ the user may interact with the in-video object. At step 942, the application completes rendering of the in-video object. In different embodiments, transparent screens may be used for different purposes. The transparent screens may be used as a display, such that generated information by the user related to a selected element may be injected into the DOM tree at the respective additional element. The injection into the additional element, thereby, associates the generated information to a portion of video content represented by the selected element. The additional elements, thereby, acting as an invisible context layer (transparent screen or visual overlay) to the video content. The context layer relates the content of the video to the content created by the user. In other embodiments, the transparent screen may also be used as an input mechanism for the user to mark a coordinate location on the video frame or image they are viewing, as well as generated content through attached input boxes.

In some embodiments, a URI may still need to be used by the platform to locate the online content being shared. Any additional layer of functionality may be managed by the platform (via the content managers) as opposed to the URI. In the example of video content, the video's URI, in some instances, use parameters to define the start position of the video after the video is loaded. By moving this functionality to the platform's content managers (such as the video manager 540) through the use of standard webpage objects, such as HTML tags, javascript libraries, and website APIs, the platform may replace some of the URI functionality while additionally enhancing said functionality. In embodiments where there are no other means to affect functionality, the application may still use the standard URI parameters to provide basic functionality with respect to the shared content.

### Responding to In-Video Content

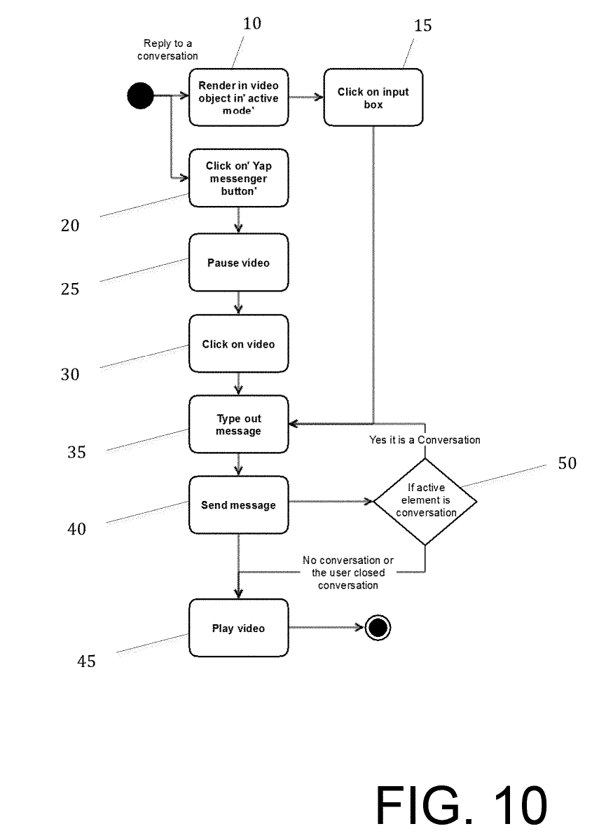

FIG. 10 is a flow diagram of an example method for user interaction in the interactive communication platform of FIG. 6. FIG. 10 illustrates the method by which a user, once a conversation is open on a video, may proceed to communicate with another user. As generally shown in FIG. 10, once a conversation in a video is opened (in an ‘opened’ state 624 by clicking on an in-video marker on the frame 616 or on a notification 626 they have received as shown in FIG. 6), a user may reply to that conversation by inputting their message (e.g., via an in-content messenger) and sending. If the user wishes to continue enjoying their video they simply have to close the conversation to move on. The user can also create new content within the same page or another. The user can then send a message to another user, who may respond to the message including sending a message on a same or different selected portion of the video. Once the users close their own conversation (messenger), the application returns the video object to ‘passive mode’ for the user to continuing playing/watching the video.

FIG. 10 specifically illustrates an example method of interaction for the user to reply to the conversation. The user may have activated an in-video object by clicking on it at step 940 or by redirection at step 926, as shown in FIG. 9. This renders the in-video object in active mode at step 10 (step 930 of FIG. 9 also shows this rendering). The open in-video object may include some form of input device for the user to use at step 15. They may then write a response to the content in the in-video object or add additional content to it at step 35 and send it to the application back end 425 at step 40. After which, the user may choose, at step 50, whether to continue interacting with the activated object, or continue watching their original content, at step 45. Alternatively, the user may create new content when they, at step 20, click on a messenger button of the dashboard 570 control to activate the transparent screen (as shown at step 614 of FIG. 6), after which at step 25, the application pauses the video to make context selection easier for the user. At step 30, the user may then click on the data wrapper (the transparent context layer) which overlays the video, which simulates allowing the user to click on the video frame. In some embodiments, the user may, through this click, provide the application with the physical coordinates as well as the time reference for the object they want to share through these actions. At step 35, the user inputs a textual message and, at step 40, sends the message to another user. After the conversation is complete, at step 45, the video continues playing and the in-video object returns to ‘passive mode’. This allows for quick sharing with only minimal interruption to the viewing experience. The user may, then, respond to the information shared with them or continue watching their content at their leisure.

### Mobile Extension

The present invention can be extended in some embodiments to function on other devices besides the aforementioned desktop and web browser using devices. Embodiments may include, but are not limited to, applications for smartphones, tablets, smart TVs, Virtual Reality gear, and augmented reality gear. The core functionality of the invention, as described by FIG. 2, is to be able to create and consume content overlaid on already existing web content without modifying the underlying, origin content. As well, being able to share, push, and request such user-authored content from other users online. This would mean that as long as the underlying software and hardware environment supports retrieving and rendering online content, an embodiment of the present invention can be formed to suit the given environment.

### Analytics

Information related to additional context verification test/factors used in determining the performance of interactively communicating within online content (e.g., user click input and coordinates), including information regarding which tests/factors are successfully applied versus those that were processed but were not successfully applied can be used to improve the quality of the online content communication engine. For example, an analytics tool (such as a web analytics tool or BI tool) may produce various metrics such as measures of additional context verification factor/test success based on the combination of other criteria (e.g. environment variables associated with level of user interaction with the online content), and filter these results by time of the day or time period or location. Such measures can be viewed per test/factor to help improve online content communication engine/agent/tool because the results may be aggregated across a multitude of devices, users, and third party service providers.

An analytics tool offers the possibility of associating other quantitative data beside frequency data with a successful test/factor application. For instance, the results of high performance in interactively communicating within the online content could be joined against the metrics derived by an analytics system (such as a web analytics solution or a business intelligence solution).

Furthermore, analytics data for interactive communication within online content for a user can be aggregated per type of user. For example, it could be of interest to know which types of tests/factors are most or least conducive to a high performance in the interactive communication, or on the contrary, applied to a low performance in the interactive communication.

While this invention has been particularly shown and described with references to example embodiments thereof, it will be understood by those skilled in the art that various changes in form and details may be made therein without departing from the scope of the invention encompassed by the appended claims.

What is claimed is:

1. A method of interactive communication within online content, the method comprising:
analyzing displayed online content at a first computing device of a first user, the displayed online content from a document object model of the online content;
generating a transparent context layer on the online content, wherein attaching elements to existing objects of the document object model to generate the transparent context layer;
selecting a portion of the displayed online content, the selected portion mapping to an existing object of the document object model;
providing information on the selected portion as communication to a second user, the provided information placed as metadata in one of the elements attached to the mapped existing object;
transmitting, by the first computing device, the metadata, to a server as an in-video object to be stored and organized at the server; and
retrieving the in-video object from the server using a second device of the second user, wherein presenting the in-video object at the second device.

2. The method of claim 1, wherein the online content is at least one of: a web page, an image, a video, and an audio recording.

3. The method of claim 1, wherein the selected portion is a specific moment in the online content.

4. The method of claim 1, wherein
the in-video data being created by a human actor or a non-human actor; and
the in-video data being provided by a human actor or a non-human actor.

5. The method of claim 1, wherein the existing objects comprise HTML objects, including a video HTML5 element tag.

6. The method of claim 1, wherein at least one of: a reference time and a position of the mapped object is placed one or more of: in, around, and over the attached element.

7. The method of claim 1, wherein the generating of the transparent context layer further comprises:
identifying objects in the document object model base on type of the objects;
extracting and dissecting the identified objects based on element type and known structure of the document object model to select a subset of the identified objects;
for each of the subset of selected objects, attaching a new element to the respective selected object within the document object model, the attached new elements comprising the transparent context layer.

8. The method of claim 7, wherein CSS styling places each of the attached new elements at a higher z-index than the respective selected object within a stacking context, or at a higher stacking order than a stacking context to which the respective selected object is a descendant to enable each of the attached new elements to visually overlap above the respective selected object.

9. A computer system that enables interactive communication within online content, the computer system comprising:
a first computing device of a first user having one or more processors and associated memory, the first computing device executing as a web-based client and configured to:
analyze displayed online content at a computing device of a first user, the displayed online content from a document object model of the online content;
generate a transparent context layer on the online content, wherein attaching elements to existing objects of the document object model to generate the transparent context layer;
select a portion of the displayed online content, the selected portion mapping to an existing object of the data model;
provide information on the selected portion to communication to a second user, the provided information placed as metadata in an element attached to the mapped existing object; and
transmitting, by the first computing device, the document object model, with the attached element, to a server as an in-video object;
the server having one or more processors and associated memory, the server executing as a web-based server and configured to:
retrieve, organize, and store the in-video object from the first computing device; and
a second computing device of the second user having one or more processors and associated memory, the second computing device executing as a web client and configured to:
retrieve the organized in-video object from the server using a second device of the second user; and
present the in-video object at the second device.

10. The computer system of claim 9, wherein the online content is at least one of: a web page an image, a video, and an audio recording.

11. The computer system of claim 9, wherein the selected portion is a specific moment in the online content.

12. The computer system of claim 9, wherein
the in-video data being created by a human actor or a non-human actor; and
the in-video data being provided by a human actor or a non-human actor.

13. The computer system of claim 9, wherein the existing objects comprising HTML objects, including a video HTML5 element tag.

14. The computer system of claim 9, wherein at least one of: a reference time and a position of the mapped object is placed one or more of: in, around, and over the attached element.

15. The computer system of claim 9, wherein the generating of the transparent context layer further comprises:
identifying objects in the document object model based on type of the objects;
extracting and dissecting the identified objects based on element type and known structure of the document object model to select a subset of the identified objects;
for each of the subset of selected objects, attaching a new element to the respective selected object within the document object model, the attached new elements comprising the transparent context layer.

16. The computer system of claim 15, wherein CSS styling places each of the attached new elements at a higher z-index than the respective selected object within a stacking context, or at a higher stacking order than a stacking context to which the respective selected object is a descendant to enable each of the attached new elements to visually overlap above the respective selected object.

17. The method of claim 1, wherein the in-video object is populated with provided product information.

18. The computer system of claim 9, wherein the in-video object is populated with provided product information.

19. The method of claim 8, wherein the stacking context to which the respective selected object is a descendant is an ancestor node's stacking context.

20. The computer system of claim 16, wherein the stacking context to which the respective selected object is a descendant is an ancestor node's stacking context.
